(19) United States
(12) Patent Application Publication
(10) Pub. No.: US 2009/0234682 A1
(43) Pub. Date: Sep. 17, 2009

(54) METHOD AND APPARATUS FOR PROVIDING AVAILABILITY OF AIRLINE SEATS

(75) Inventors: David Baggett, Hermosa Beach, CA (US); Gregory R. Galperin, Cambridge, MA (US); Carl G. DeMarcken, Cambridge, MA (US)

Correspondence Address: FISH & RICHARDSON PC, P.O. BOX 1022, MINNEAPOLIS, MN, 55440-1022, US

(73) Assignee: ITA Software, Inc., a Delaware corporation

(21) Appl. No.: 12/474,685

(22) Filed: May 29, 2009

Related U.S. Application Data
(63) Continuation of application No. 09/431,366, filed on Nov. 1, 1999, now abandoned.

(51) Int. Cl. G06Q 10/00; G06Q 50/00; G06F 17/30

(52) U.S. Cl. 705/6; 707/3; 705/5; 705/10; 707/E17.014; 707/E17.044

(57) ABSTRACT

An availability system used for a travel planning system includes a cache having entries of availability information of seats for a mode of transportation. The system includes a cache manager that manages entry information in the cache so that information in the cache is correct, current, complete or otherwise as useful as possible. The cache manager determines when a stored answer is stale and, if a stored answer is stale, sends an availability query to a source of availability information.

### BACKGROUND

This invention relates generally to determining airline seat availability information for use in travel planning and travel reservation systems.

Airlines institute selling policies that can change to meet supply and demand considerations to maximize profit on any given flight. When a passenger specifies an itinerary, the itinerary has one or more flight segments. In order to issue a ticket for a single or multi-flight segment itinerary, each flight segment must be available. That is, each flight segment must have seats that have not been already reserved for other passengers. Availability can also be governed by whether an airline will sell to a particular passenger given characteristics of the passenger. Common characteristics which are used by airlines to decide whether or not to sell a ticket is the price that the passenger is willing to pay for the ticket, whether the passenger is using other flights on that airline, whether the passenger is a frequent flyer and so forth.

Generally, before booking a flight and issuing a ticket, the seller can send a request for availability information to the airline. In general, a request for availability is sent over a computer network to an airline and is processed in the airline's computer system. An answer to the request is provided from the system. Commonly, a message is returned to the seller. The message includes one or possibly a plurality of so-called booking codes that are labels used to designate different prices that an airline is willing to sell tickets at. Associated with these booking codes or labels are often a number of seats that the airline is willing to sell in each booking code. For example, a common booking code is the “Y” booking code and the message may contain Y/25 meaning the Y booking code has 25 seats. A second booking code may be the “Q” booking code and may contain a message which says Q/0 meaning that the Q booking code has 0 seats available. Although the exact meaning of booking codes may vary from carrier to carrier, in general most carriers will use Y booking codes corresponding to an expensive coach class fare and a Q booking code as an inexpensive coach class fare. The airline would make the seat at the Y booking code available, i.e., a higher profit booking code, rather than make the seat available at the Q booking code, i.e., a lower profit fare.

### SUMMARY

Conventionally, travel agents and computer reservation services look-up a limited number of flight options. Thus, having an airline check on availability for those flights and asking a computer reservation service to perform a fare search for such flights involves a small number of availability checks, low latency and is generally acceptable. However, new algorithms have been produced for performing so-called “large scale” or “low fare searches” that iterate over a large number of flight possibilities and therefore would require looking up availability information and performing fare searches over the flight and available booking codes for many hundreds if not thousands of possible combinations. Since there is a computational expense, as well as an economic expense, involved in obtaining availability information, it is desirable to minimize this expense as much as possible. While it is necessary for good travel planning to look at many possible flight combinations such as hundreds or possibly thousands, it is undesirable to return to a traveler who requested such flight combinations large numbers of flights for which no seats are in fact available. Therefore, the need for availability information is present with a low fare search or large scale search algorithms. However, the current availability infrastructure does not allow for easy access to such queries which could take many minutes and possibly hours at high processing and economic costs.

According to an aspect of the invention, a method for managing a cache of entries containing availability information for a seat on an airline includes determining a stored answer is stale and, if the retrieved stored answer is stale, sending an actual availability query to an source of availability information for an airline.

According to an aspect of the invention, an availability system used for a travel planning system includes a cache that includes entries of availability information of seats for a mode of transportation and a cache manager that manages entry information in the cache so that information in the cache is correct, current, complete, or otherwise as useful as possible.

One or more the following advantage may be provided by one or more aspects of the invention.

The invention allows new algorithms that produce large scale or low fare searches to have access to availability information flights and available booking codes in a low cost manner. This provides a travel planning system that can look at many possible flight and return to a traveler flight combinations for which seats are in fact available.

### BRIEF DESCRIPTION OF THE DRAWINGS

FIG. 1 is a block diagram of a client server travel planning system.

FIG. 2 is a flow chart showing a server process used in the system of FIG. 1.

FIG. 3 is a block diagram of an availability database.

FIG. 4 is a block diagram of a predictor using the availability database of FIG. 4.

FIGS. 5 and 6 are flow charts of processes used with the availability database.

FIG. 7 is a block diagram a cache manager to manage an availability cache.

FIG. 7A is a block diagram of an entry in the cache including a key and data.

FIG. 8A is a flow chart of a list-based cache manager scheduler for additions/updates of entries in the availability cache.

FIG. 8B, is a block diagram of lists used in the cache manager of FIG. 8A.

FIGS. 9-10 are flow charts of an alternative cache manager process for additions/updates of entries in the availability cache.

FIGS. 11A, 11B through 13A, 13B are flow charts of an alternative cache manager process for additions/updates of entries in the availability cache.

### DESCRIPTION

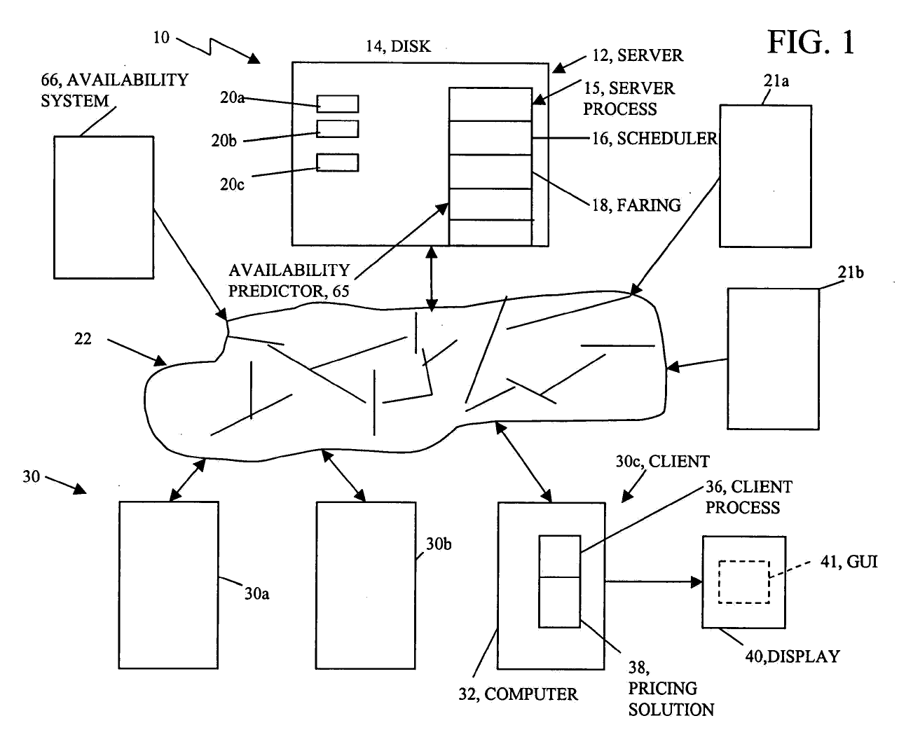

Referring now to FIG. 1, a travel planning system 10 is shown. The travel planning system 10 can be used with various forms of travel such as airline, bus and railroad and is particularly adapted for air travel. It includes a server computer 12 having a computer memory or storage media 14 storing a server process 15. The server process 15 includes a scheduler process 16 and a faring process 18. The scheduler process 16 is any scheduler process that will produce, from a travel request, sets of flights that can satisfy the request. The faring process 18 is any process that determines a set of valid fares. The server process 15 can also link a set of valid fares to flights to form a set of pricing solutions. Examples of the scheduler process 16 and the faring process 18 can be found in co-pending U.S. patent applications entitled “Scheduler System for Travel Planning System”, Ser. No. 09/109,622, filed on Jul. 2, 1998 by Carl G. Demarcken et al., and U.S. patent application entitled “Travel Planning System”, Ser. No. 09/109,327, filed on Jul. 2, 1998 by Carl G. Demarcken et al, both of which are assigned to the assignee of the present invention and incorporated herein by reference.

The travel planning system also includes a plurality of databases 20a, 20b which store industry standard information pertaining to travel, for example, airline, bus, railroad, etc. Database 20a can store flight information from a source such as the Standard Schedule Information Manual, whereas database 20b can store the Airline Traffic Publishing Company (ATPCO) database of published airline fares and their associated rules, routings and other provisions. The databases 20a, 20b are typically stored locally and updated periodically by the remote resources 21a, 21b. In addition, the system 10 can access an availability system 66 of one or more airlines (generally each airline will have its own availability system) by sending availability queries over the network 22.

The system 10 also includes an availability predictor 65. The availability predictor 65 can be based upon a cache or database of stored availability queries, a predictive model of availability and/or a simulation of an availability process or an actual availability process running as a local process to the server process 12.

The system 10 also includes a plurality of clients 30a-30c implemented by terminals or preferably personal computers. The clients are coupled to the server 12, via a network 22, that is also used to couple the remote resources 21a-21b that supply databases 20a, 20b to the server 12. The network 22 can be any local or wide area network or an arrangement such as the Internet. Clients 30a, 30b are preferably smart clients. That is, using client 30c as an illustrative example, it may include a client computer system 32 including computer memory or storage medium 34 that stores a client process 36 and a set of pricing solutions. The set of pricing solutions 38 in one embodiment is provided from the server process 15 and comprises a set of fares that are valid for a journey and associated information linking the fares to the flight segments of the journey. In an alternative arrangement, the availability predictor 65 can be part of the client process 36.

The set of pricing solutions 38 is obtained from the server 12 in response to a user request sent from the client to the server 12. The server 12 executes the server process 15 using the scheduling process 16 and the faring process 18 as mentioned in the above-identified patent applications to produce the set of pricing solutions for a particular journey. If requested by a client, the server process will deliver the set of pricing solutions to the requesting client. Under control of the client process 36, the requesting client 30c can store and/or logically manipulate the set of pricing solutions to extract or display a subset of the set of pricing solutions, as a display representation on the monitor 40.

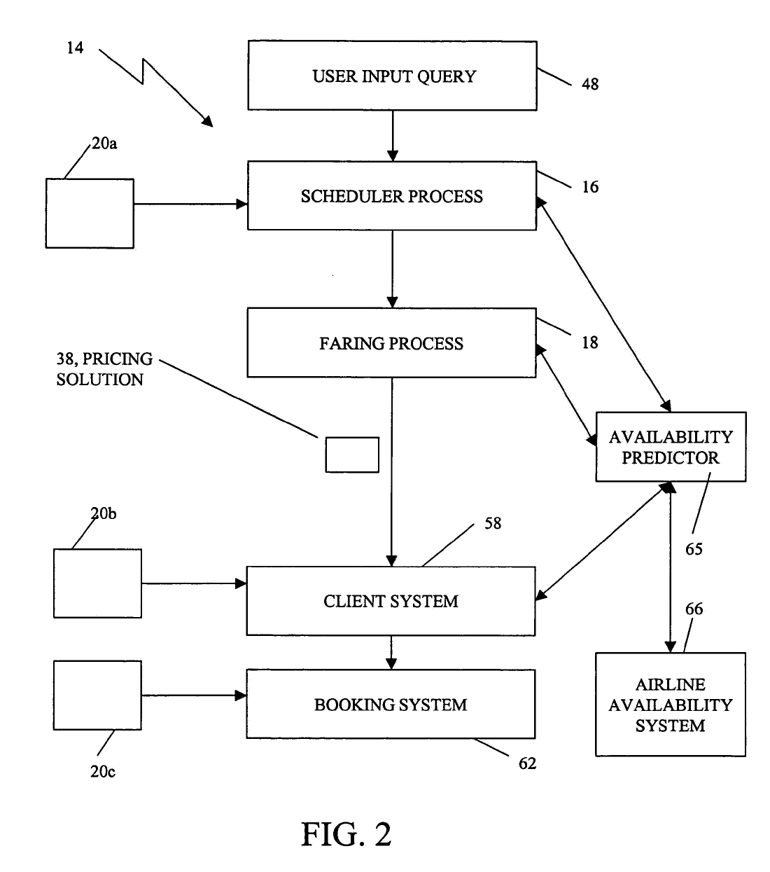

Referring now to FIG. 2, the server process 18 is preferably executed on the server computer 12 but could be executed on the client 32. The server process 18 is responsive to a user input query 48. The user input query 48 would typically include minimal information needed to determine the set of pricing solutions. This information typically requires at a minimum an origin and a destination for travel. In addition, the information could also include times, dates and so forth. This query is fed to the scheduler process 16 that produces a large number of itineraries, that is, sequences of flight segments between the origin and destination of each slice of a journey. The scheduler process provides the itineraries to a faring process 18. The faring process provides a set of pricing solutions by finding valid fares corresponding to the itineraries produced by the scheduler process 16. The faring process 18 validates the fares for inclusion in the set of pricing solutions.

The server process 18 also includes an availability predictor 65 that is used to determine airline seat availability. The availability predictor 65 can be accessed after or during the scheduler process 16, faring process 18, or within the client system 58 to determine the availability of seats on a particular flight of a particular airline. The availability predictor 65 can be implemented using various techniques, as will be described below, which may include producing actual queries that are sent to an airline availability system 66. The answers received from the queries can be used to train the availability predictor 65. From the pricing solution information 38 and the availability information provided from the availability predictor 65, a client system or other system can access 58 a booking system 62 to issue a ticket for a customer.

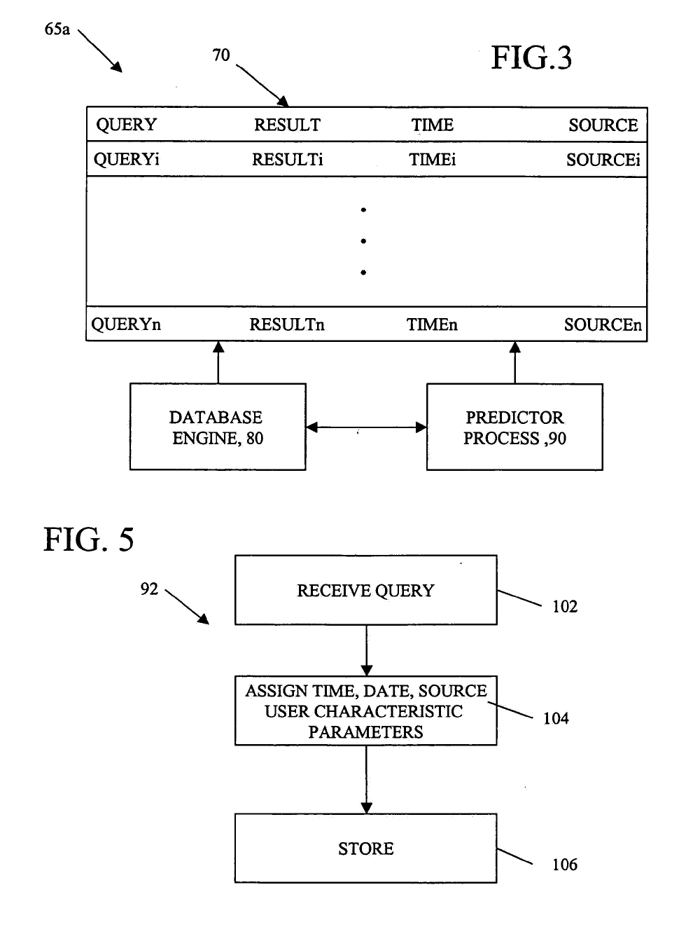

Referring now to FIG. 3, a first embodiment 65a of an availability predictor 65 includes a database 70, a database engine 80 and a predictor process 90. The database 70 stores availability queries and answers as shown. The database 70 includes queries and answers that were obtained by the availability predictor 65a when the availability predictor 65a could not trust or provide a prediction and thus issued an actual availability query, as well as, queries that are received from other sources. For example, the availability predictor can be run as part of a server process by a computer reservation service (CRS). The CRS may have access to availability queries that are run by travel agents, for example, that are associated with the computer reservation service. The queries and the results of these queries can be forwarded and stored in the database 70. The database 70 will contain the query such as shown below. For a query involving a single flight:

| Airl | Flt# | Orig | Dest | Date | TripOrigin | TripDest | SoldIn | SoldBy |
|---|---|---|---|---|---|---|---|---|
| AA | 1822 | BOS | DEN | 25MAR99 | BOS | LAX | US | Amer. Expr. |

or for a query involving multiple flights:

| Airl | Flt | Orig | Dest | Date | TripOrigin | TripDest | SoldIn | SoldBy |
|---|---|---|---|---|---|---|---|---|
| AA | 1822 | BOS | DEN | 25MAR99 | BOS | LAX | US | Amer. Expr. |
| AA | 0421 | DEN | LAX | 25MAR99 | BOS | LAX | US | Amer. Expr. |

A result will generally comprise a message such as shown below:—

| Airl | Flt# | Orig | Dest | Date | BookingCodes&Counts |
|---|---|---|---|---|---|
| AA | 1822 | BOS | DEN | 25MAR99 | F0 C0 Y9 M5 K5 L0 QO |

or

| Airl | Flt# | Orig | Dest | Date | BookingC0des&C0unts |
|---|---|---|---|---|---|
| AA | 1822 | BOS | DEN | 25MAR99 | F0 C0 Y9 M5 K5 L0 QO |
| AA | 0421 | DEN | LAX | 25MAR99 | F1 C0 Y4 M5 K1 L1 Q1 |

Additional information can be stored in the database 70 which may typically be generated by the availability predictor 65a. For example, the query can be stored along with an entry that corresponds to the time and/or date that the query was stored, received, and/or generated. The source of the query can also be noted. In addition, other information may also be stored with the query such as characteristics of the customer or traveler. Such characteristics may include the traveler's nationality, point of purchase or status such as whether the traveler is a frequent flyer or whether the traveler is booking other flights on the airline to which the query was directed and so forth. The database 70 can also be populated by routine direct queries even in the absence of queries made to the predictor so that, when a question is asked of the predictor, it is less likely that a direct query would have to be made. For example, the database 70 may be populated during off peak times for travel agents or may be simply populated with such routine queries when the system is not otherwise in use.

The database engine 80 populates the database 70. The engine 80 can produce queries of certain types depending upon the relative factors involved in any particular flight and/or airline. Such routine queries could be automatically produced by the database engine 80 for those markets and/or flights in which air travel is particularly heavy or during such periods of time where air travel between particular origins and destinations would be particularly heavy.

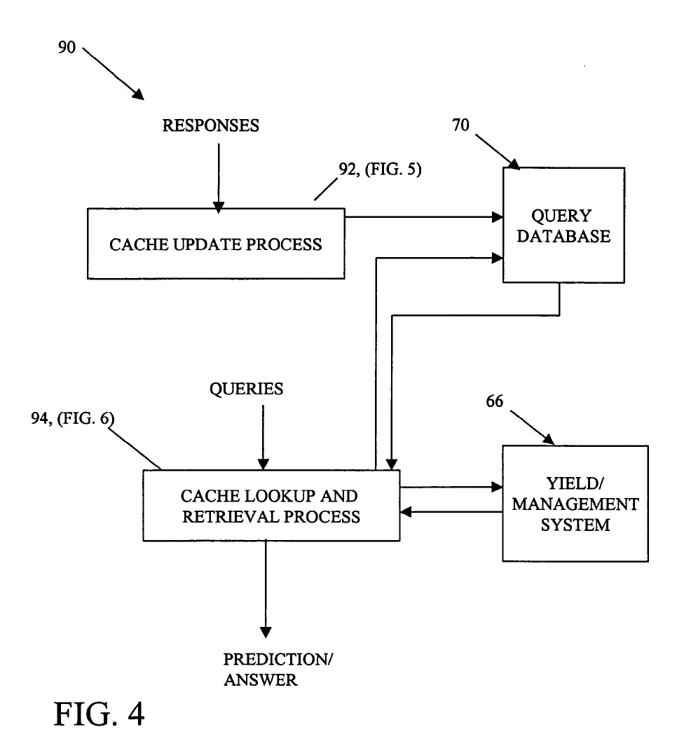

Referring now to FIG. 4, the predictor process 90 that uses the database 70 to provide predicted availability answers is shown. The predictor process 90 includes an update process 92 that interfaces with the query database 70 (FIG. 3) and database engine 80 to make sure that the query database 70 contains the most current information available for the availability predictor 90. The update process 92 takes responses that are received from queries made by the availability predictor 90, as well as other sources, and populates them into the query database 70 as appropriate. The predictor 90 also includes a look-up and retrieval process 94 that interfaces with the query database 70, as well as the yield management (availability) system 66 (FIG. 2) that is coupled in a conventional manner to an airline availability system. In response to a query, the look-up and retrieval process 94 produces either a prediction for the answer of the query or an actual answer depending upon whether the look-up and retrieval process retrieves an answer from the database 70 or the yield management system 66.

Referring now to FIG. 5, the update process 92 receives a query 102 from either the availability predictor 90 or from other sources, as described in conjunction with FIG. 3. The update process 92 assigns 104 a time, date, source, and user characteristic parameters, if available, as appropriate and stores 106 the query along with the answer and the assigned parameters in the query database 70.

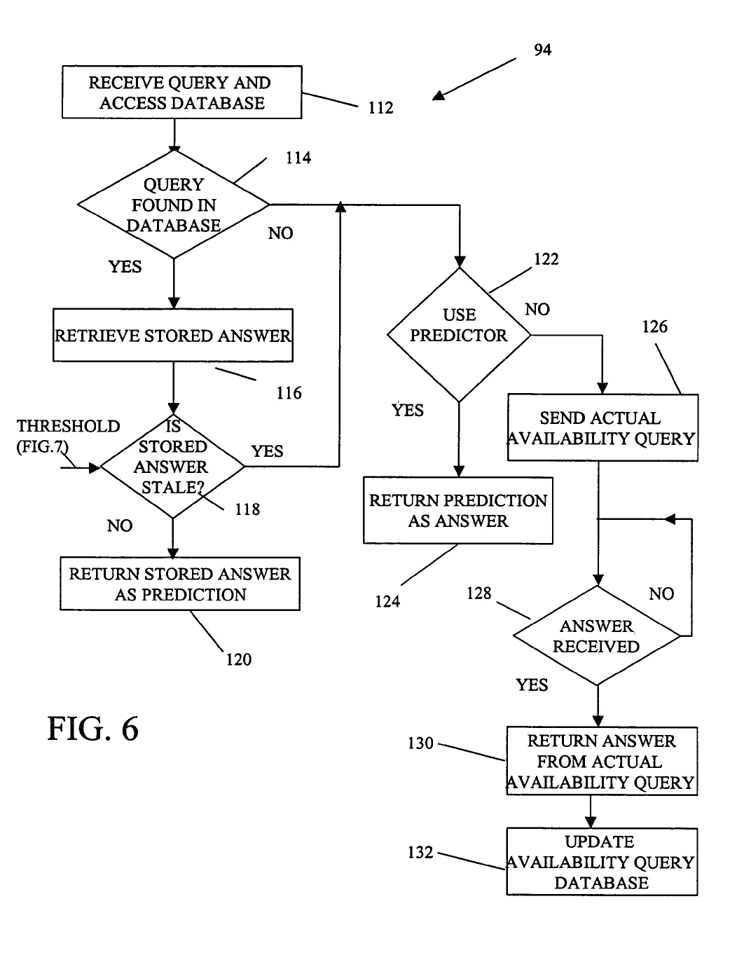

Referring now to FIG. 6, the look-up and retrieval process 94 receives a query that may have originated from the server process 15. The server process 15 may have a series of flights, fares and/or linked combinations thereof, for which availability information is needed. The server process 15 can construct an availability query for flight-segments it is using or considering using by collecting necessary information from the scheduling database 20a. The information can include airline, flight number or numbers, origin and destination airports, and travel date. In addition, the information can also include trip origin and destination if different than the origin and destination of the queried flight-segments. Queries may also include information about the selling location or agency. For travel involving multiple flight-segments, individual queries may be constructed for each flight segment, or a single query for multiple flight-segments might be constructed. The server process 15 sends the query to the availability predictor 65a.

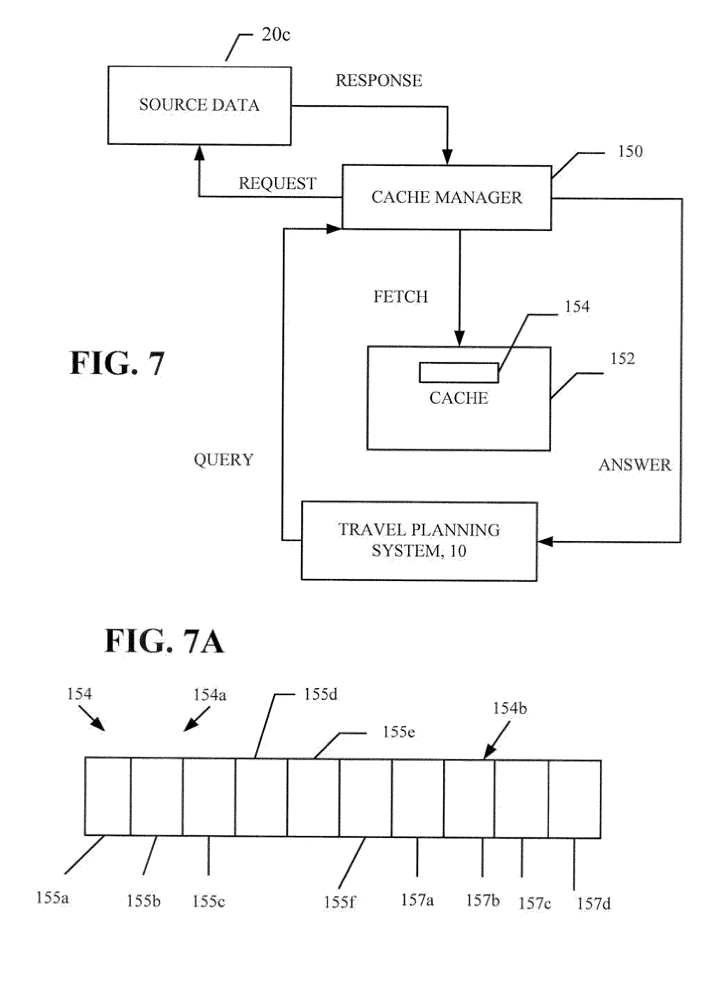

The look-up and retrieval process 94 will look up 112 the received query in the query database 70 by attempting to match the query fields such as airline, flight number/numbers, date, trip origin and destination, sale location and agency. If a stored query is found 114 in the query database 70 that matches the received query or which is substantially close in characteristics to the received query, the process 94 will retrieve 116 the stored answer. The process 94 will determine if the stored answer is stale 118 by comparing the time of the query to a threshold time that can be either a preset threshold such as a certain number of minutes, hours or days or preferably a variable threshold that is determined in accordance with a threshold level predictor 120 (FIG. 7). If the answer is not stale, then the look-up and retrieval process 94 will return 120 the stored answer as a prediction of the availability of a seat on a particular flight according to the availability query.

If the query was not found in the database 70 or if the stored query which was found is stale, the look-up and retrieval process 94 optionally can determine 122 whether or not to use another predictor. If the look-up and retrieval process 94 has this option, the process 94 will return 124 the prediction from those predictors, as the prediction from the availability predictor 65a. Otherwise, if the look-up and retrieval process 94 does not have a predictor or does not trust the predictor, then the process can send 126 an actual availability query to the airline availability system 66 (FIG. 2). The answer that is received 128 from the airline availability system 66 is returned 130 as the answer and can be used to update 130 the database 70. The database 70 can be implemented using various approaches including hierarchial, relational or object oriented databases, or alternatively, a software or hardware cache. In addition, the answer can include a confidence factor based on whether the query is stale or whether an actual query was performed.

Referring to FIG. 7, a database manager here implemented as a cache manager 150 to manage a cache 152 is shown. The cache 152 manager 150 manages the cache 152 of airline seat availability information to aid the prediction of such seat availability information for use in travel planning system 10. The cache 152 typically contains entries 154 corresponding to seat availability data for various modes of transportation such as airline travel, as described above. As described, typically a server or client requiring availability predictions will query the cache 152 through the cache manager 150 with an availability query, and the cache manager 150 will examine the cache 152, retrieving an answer stored therein to return as the response to the availability query.

The cache manager 150 gathers data to put in the cache 152. One technique is to fill the cache 152 based on whether a query misses the cache 152 (the datum is not found in the cache 152), and produces a “live query” direct to the availability data source. The result is stored in the cache 152 for later retrieval as well as returned to the travel planning system which originated the query.

The cache manager 150 provides additional processing in order to keep the highest quality information in the cache 152 so that the query responses are as useful as possible. The cache manager 150 can operate when availability queries to the cache 152 are not being made or are not pending, or can operate continually (“in the background” or “as a daemon”) independent of the availability queries posed to the cache 152. The cache manager 150 implements a management strategy that is dependant on the availability queries being posed to the cache 152.

A travel planning system needs to make availability queries to gather data to complete the travel planning processing. Since availability data is expected to change slowly relative to query rates, and since live availability queries to the airlines can be costly in both time and money, a cache is inserted between the travel planning system and the source of availability data. Furthermore, a cache manager 150 is inserted between the availability cache 152 and the source 20c of availability data, to proactively populate the cache 152 to maintain a high quality level of data in the cache 152 for quick and easy access by the travel planning system 10.

The original source of availability data need not be a direct connection to the airlines' availability systems (whether that be a database, a yield management system, a revenue management system, or other such system); it can be any other such source, e.g. an availability prediction system, another database or cache, or a simulation of the airlines' systems. The description given is applicable for any availability source irrespective of the origin of the data.

Referring to FIG. 7A, an entry 154 in the cache includes a key 154a and data 154b. The key 154a is the identifier of a specific instance of a flight, including the airline 155a, the flight number 155b, the origin 155c, the destination 155d, the departure date 155e, and the departure time 155f. For example, this might be “TW391302SEP BOS-JFK 5:40” meaning airline TW (Trans World Airlines), flight#3913, leaving BOS (Boston Logan) at 5:40 am on Sep. 2nd, destined for JFK (JFK Intl. Airport, New York). The data 154b are the seat availability counts, and includes of a list 157a-157d of booking classes and number of seats available in each. For instance, this might be “F4 Y4 V3 S1 E0 L0” to indicate 4 seats available in F class, 4 seats available in Y class, 3 seats in V class, 1 in S, and none in E or L.

The cache 152 might be a single database or multiple databases (as in a distributed cache) which may be non-overlapping or overlapping to any degree; if distributed, the cache may be distributed between threads or processes on one machine, or distributed between multiple machines or networks; but for the purposes of this discussion the cache can and should be considered as a single logical unit.

The cache manager 150 determines what entries are to be kept in the cache, and submits appropriate “Requests” to the availability source 20c at the appropriate time to obtain the “Responses” that are stored in the cache 152. For instance, the cache manager 150 might decide that the cache 152 should keep the entry “UA175 24DEC BOS-LAX 8.15” but not the entry “CO4097 12MAR BOS-CLE 11:30,” possibly deleting the second entry if already entered. Further, the cache manager 150 might decide that a query should be submitted to the source to gather fresh data about the entry “DL1823 04NOV BOS-LGA 7:30” and either update that entry in the cache or add it if not already present.

Set forth below are several cache management strategies. In practice multiple strategies can be mixed together and executed simultaneously to meet multiple goals at once. The availability system uses data sources which asynchronously notify a travel planning system 10 of schedule changes or updates; the cache manager 150 can track these notifications and use the information contained therein to further guide cache insertion and deletion. For instance if the cache manager 150 receives a schedule change notification that a flight has been canceled, it can remove all entries relating to that flight from its cache. Similarly, if it receives notification that a flight has been added, it can create entries related to that flight and place them on lists to be added or modified in the cache. Finally, there are data sources such as so-called “AVS messages” which asynchronously notify the system of availability data of certain flights; the cache manager 150 can treat those just as it would responses directly from the availability data sources, and enter that data into the appropriate entries in the cache if appropriate, add entries to the cache, or simply ignore the messages.

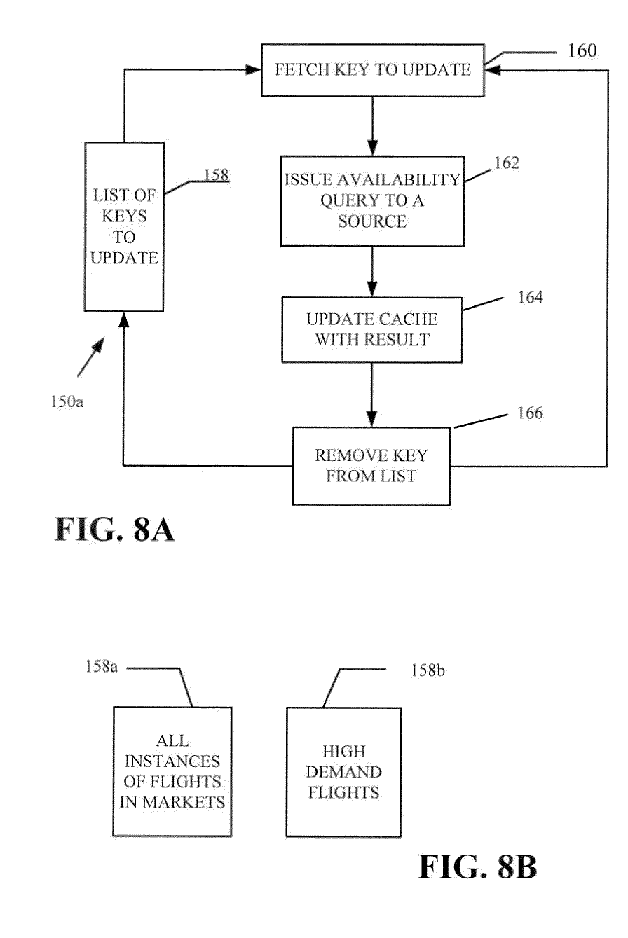

Referring to FIG. 8, one cache manager 150 is a list-based schedule for additions/updates, where one or more lists 158 of keys of entries to update or add are generated externally and given to the cache manager 150. To process a single list, for each entry on the list in the order given, the cache manager 150 fetches 160 a key to update, submits 162 a query to the availability source and stores 164 the result in the cache, updating an entry if present and adding an entry if not. The cache manager can remove 166 the entry key from the list. When the cache manager 150 reaches the end of the list, cache manager 150 repeats the process from the start of the list.

If the cache manager 150 is given multiple lists, the cache manager 150 processes one entry from each list as described above, circling round-robin through the lists in turn until one entry has been processed from each list, then returning to the first list to process the next entry, etc.

Any given key representing an instance of a flight may be in none, one, or multiple lists. For example, if there are three lists (where entry keys are represent by these codes, as follows: List 1 has four entries 1A, 1B, 1C, and 1D; list 2 has three entries 2A, 2B, and 2C; and list 3 has only one entry 3A. An order of processing entries could be 1A, 2A, 3A, 1B, 2B, 3A, 1C, 2C, 3A, 1D, 2A, 3A, 1A, 2B, 3A, etc. That is, the processing has each list contributing every third entry to the processing. Also any given entry in a shorter list is processed more often than an entry in a longer list, providing a natural mechanism for specifying flights to be processed more frequently than others.

Referring to FIG. 8B, the cache manager 150 is given lists of flights which are already compiled. The lists are complied according to the needs of the travel planning system 10. One list 158a could contain an exhaustive list of all instances of flights between markets of interest within a date range of interest, such as “all domestic U.S. flights in the next 3 months.” To create this list flight scheduling data listing all flights is filtered to select out the flights matching the desired criteria. While this first list ensures that all flights are in the cache, because querying an availability source takes a non-trivial amount of time some entries in the cache maybe quite old. A second list 158b could be made containing the flights which are in high demand or which are likely to be used in travel planning by using prior knowledge of the air travel demand such as busy travel days (e.g. holidays), important or busy markets (e.g. BOS-NYC), or busy travel times (e.g. Friday and Sunday nights). Using the first and second lists together has the effect that the higher demand flights would be queried more often (the process would finish the list and return to the start sooner) and thus that data would be fresher.

The cache manager 150 could process the entries in the list in the ordered fashion as described above, or alternately could process entries in each list in random order (i.e., randomly shuffle the list before processing as above). The first has the advantage that an external agent could predict how old each piece of data will probably be by determining where in the list the manager currently is, but has the disadvantage that depending on the order of the list (alphabetical by market for instance) this technique might result in all the availability queries associated with a single travel planning session returning stale data. The second has the advantage that similar availability queries (or availability queries likely to be used together in a given travel planning session) are less likely to be uniformly stale, but has the disadvantage that the quality of the result is less easily predictable (but still predictable if the order is known). Some other criteria could be used to order the flights for ordered processing, such as a schedule which ensures a diverse set of data will always be fresh (e.g., list one flight in each market, then list a second flight in each market, etc.).

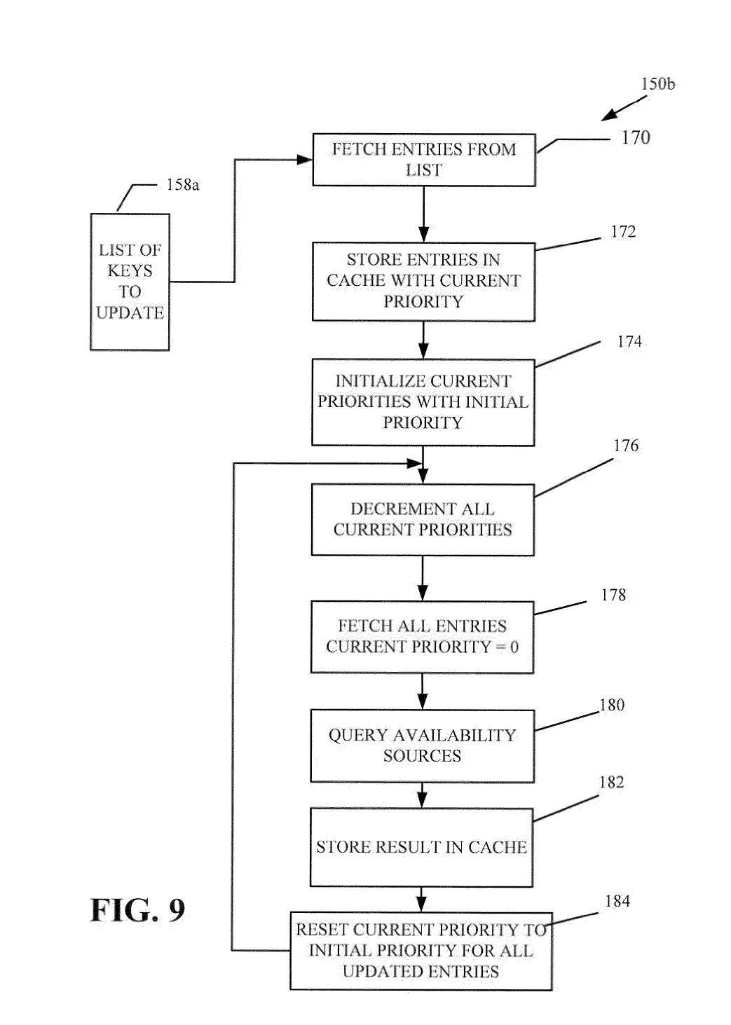

Referring to FIG. 9, while the multiple-list approach above can be seen as a system having only a few priority levels, one per file (each level corresponding to a sampling rate determined by the file length), a second cache manager process 150b having a finer-grained ordering of processing would be to assign a priority to each entry. In this case a single list of the entries 158a to have in the cache is provided, preferably an exhaustive list of all flights of interest, and each entry is annotated with an integer relative priority value. The cache manager 150 reads 170 in the list of entries and the priority value (“initial-priority”) for each, storing them in the cache along with an additional value “current-priority” 172. The manager proceeds to initialize 174 all current-priorities with the corresponding initial-priority, and for every entry, decrease 176 its current-priority by 1. The manager process 150b finds 178 all entries in the list for which current-priority=0, the manager process 150b queries 180 the availability source for that entry and stores 182 the result in the cache, and resets 184 the current-priority of the updated entries to their initial-priority. The manager reinitializes a next set of priorities by decreasing 176 all current priorities.

This manager allows a different priority for each flight, with the associated overhead of maintaining that information (additional memory per flight is needed to record the current and initial priorities; additional computational cost is needed to select the highest priority flight to query at every step). Clever data structures and computation can help reduce but not eliminate these costs: for instance, the above is equivalent to the following more efficient algorithm that keeps a priority queue (implemented with a heap) of entries prioritized on its next processing time:

1. current-step<-0
2. for each entry in the list, add it to priority queue Q with priority initial-priority
3. remove the entry from Q with the minimum priority value P
4. query the availability source for that entry and store the result in the cache, and
5. add the entry to Q with new priority P+initial-priority
6. go to 3.

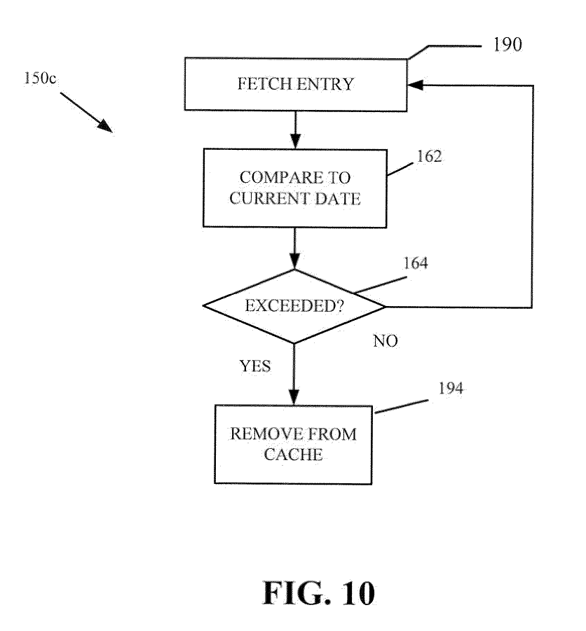

Referring to FIG. 10, the above methods work well for adding or modifying entries in the cache. The manager process 150c in FIG. 10 provides for removal of entries from the cache. This manager 150c implements a date-based strategy for removal. The manager logic removes flights scheduled to fly in the past. The manager examines 190 each entry in the cache and removes 194 the entry if the date specified in the key is less than the current date 192. It makes clear sense to remove flights which have already flown when the sole aim of the travel planning system is to sell future tickets. For slightly different applications such as travel planning using historical data, the logic could be modified easily to remove flights which are older than some specified date, such as “remove all flights one month old or more.”

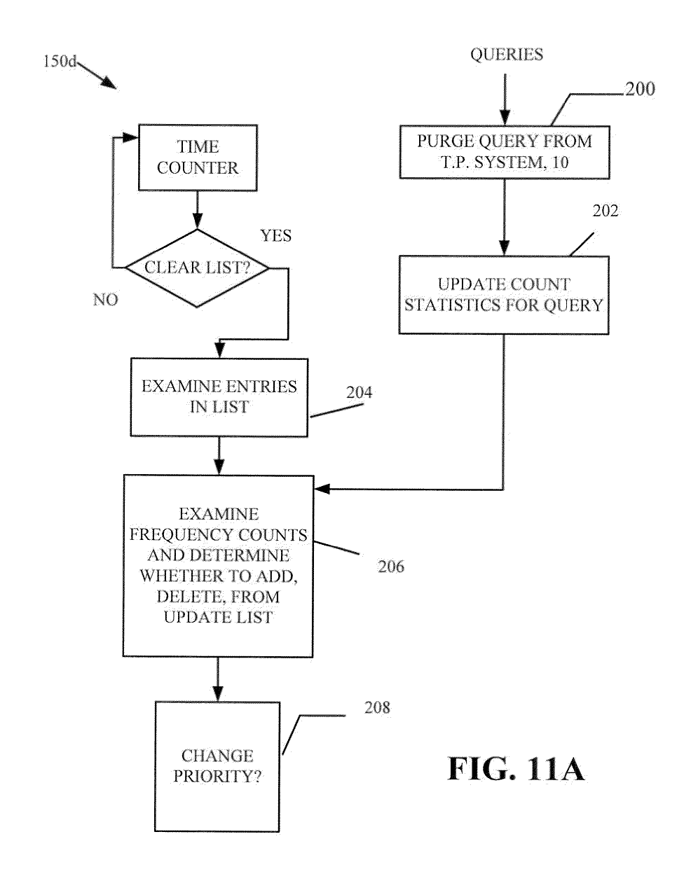

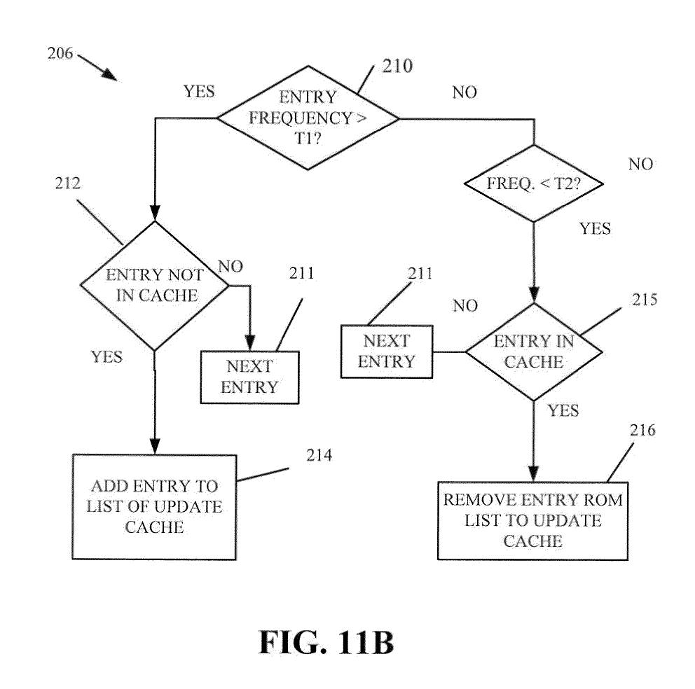

Referring to FIG. 11A, another manage process 150d for determining what entries are important to add, delete, or update is based on demand. The cache manager 150 monitors and examines the availability queries made to the cache by the travel planning system to determine which flights (or set of flights, such as the flights for a certain day, date, or market) have a high demand for availability information. If a flight is determined to have a higher than average or higher than expected demand, then it might be added to the cache earlier than it would have been otherwise, or it might be updated more often to make sure the information is fresh. The internal accounting to affect this change could be achieved by several of the mechanisms described here, such as elevating its priority or adding it to a separate list of high-demand flights.

To implement this strategy the cache manager process 150e observes and parses 200 queries made to the cache by the travel planning system and updates 202 a list of entries queried along with a frequency count tallying the number of times each entry has been accessed. The cache manager process 150d examines 204 each entry in the list and, based on its frequency of access, determines 206 whether the entry should be added or deleted from the cache, or determines 208 whether its priority should be raised or lowered to freshen the data for that entry from the availability source more or less often, respectively. The list is cleared and the counts reset to 0 at regular intervals e.g., every 3 hours.

Referring to FIG. 11B, one implementation of the examining process 206 involves using preset thresholds for adding or removing the entry. Thus, if the frequency is above threshold level T1 210 and the entry is not in the cache 212 it is added 214 to the list to access an availability source; if the frequency is below threshold level T2 and the entry is in the cache it is removed 216.

Also, a preset mapping from access frequency to priority can be defined functionally, such as a linear relationship between the two. To gather statistics over a longer time but still adapt the priorities and cache entries in the same time frame, multiple lists of accesses may be kept simultaneously, each with its own set of access frequency counts. When the cache manager process 150d observes a single availability query, it tallies one more count for that entry in all active lists. Typically one will be examined, processed, and deleted at a time, making a new empty list to replace it. For instance, to have adjustments every hour based on statistics gathered over the past six hours, six lists are maintained simultaneously, and every hour the oldest is processed removed, and replaced with a new empty list. This examination process above is extremely fine-grained (one access frequency per entry in each list), and is suitable when there is a high volume of availability queries made to the cache or when fine-grained control over the cache is desirable (e.g., when cache memory is limited, for instance).

However this exhibits poor or no generalization properties: two entries on the same airline, on the same day, between the same endpoints, and an hour apart may have Very different caching characteristics if their access frequencies are different. In order to automatically detect busy days, busy markets, busy flight times, etc., aggregate statistics are kept. For instance, instead of having an access count covering only the one cache entry “US6309 11DECBOS-LGA 10:00”, there are multiple access counts affected by that entry, one covering “all US6309 flights for all days,” another covering “all BOS-LGA flights between 10:00 am and noon,” another covering “all USAir flights out of BOS before 11:00 am,” and yet another covering “flights into LGA on Saturdays more than a month from now.” All these aggregate access counts are processed equivalently to their fine-grained counterparts and any modifications to cache entries made as a result, are made to all matching flights.

Another version of this system replaces the process of gathering access counts in real time with a predictor of that value. One way of making such a predictor is to model one from historical data as follows: the above system is run to gather a database of lists of entries and access counts: instead of deleting the lists as prescribed above, the list is collected in a database for later processing. When the database is large enough, corresponding entries (e.g., “all US Air flights out of BOS before 11:00 am” or “US6309 11DEC BOS-LGA 10:00”) are averaged to get one mean predicted value for each entry in the list. A list of these averages is then used rather than constructed lists described above. While entries referring to specific absolute dates are unlikely to generalize and should largely be omitted from the compiled list, entries making reference to relative dates (such as “one week from now”) are likely to be very useful.

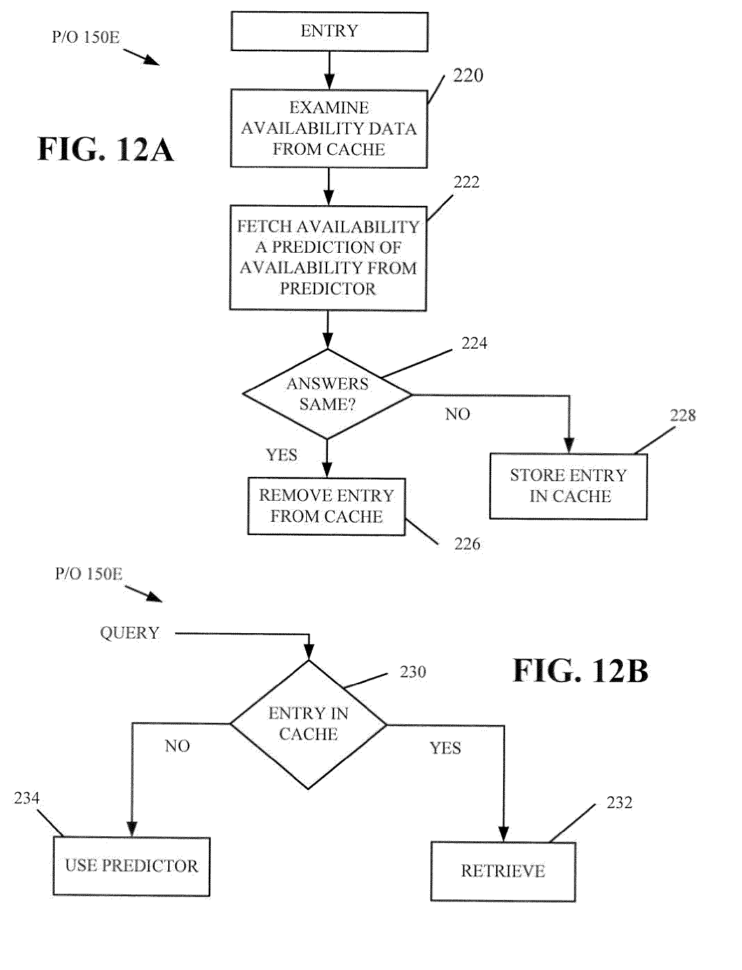

Referring to FIG. 12A, another manager process 150e attempts to reduce the size of the cache by using a predictor of availability to answer cache misses. In this manager process 150e the cache mechanism itself is modified so that writes to the cache and reads from the cache are processed according to the logic below. The availability predictor is described in detail in U.S. patent application entitled “Method and Apparatus for Providing Availability of Airline Seats” referred to above. Given such a predictor, any entry whose availability data agrees with what is predicted is not stored in the cache, while only entries whose availability data disagrees with the predicted values are kept in the cache.

Algorithm for writing entry E with data D to cache examine availability data 220:

1. The predictor is used to predict the availability data Dp for E 222
2. If Dp=D, (predictor is correct so entry should not be in cache) 224
3. If entry E is in the cache remove it. 226
4. else write entry E into cache (or modify E if it is already in the cache) 228

As shown in FIG. 12B, an algorithm for reading entry E from the cache:

1. Determines 230 if entry E is in the cache
2. retrieve 232 data from cache for E and return that value
3. else use 234 the predictor to predict the availability data and return that.

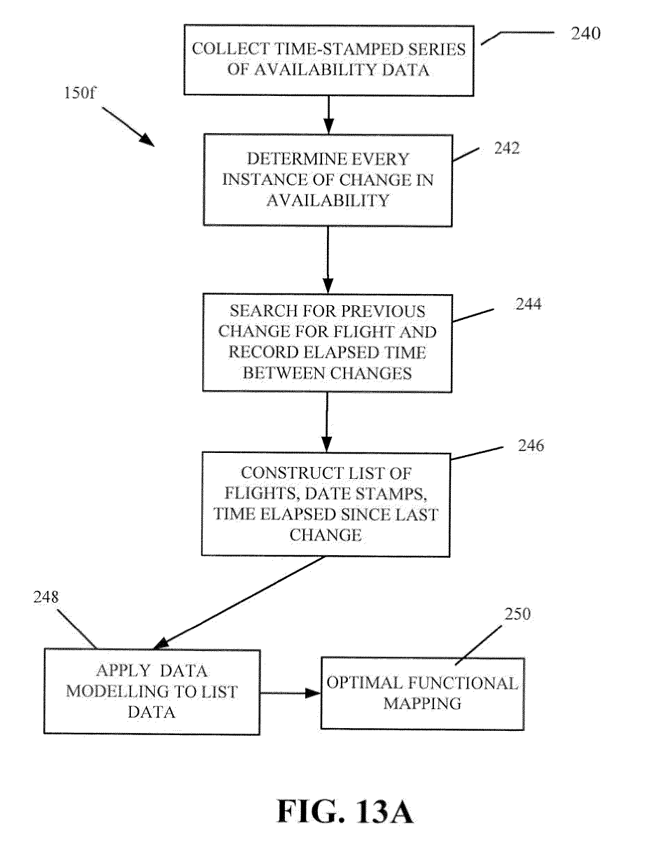

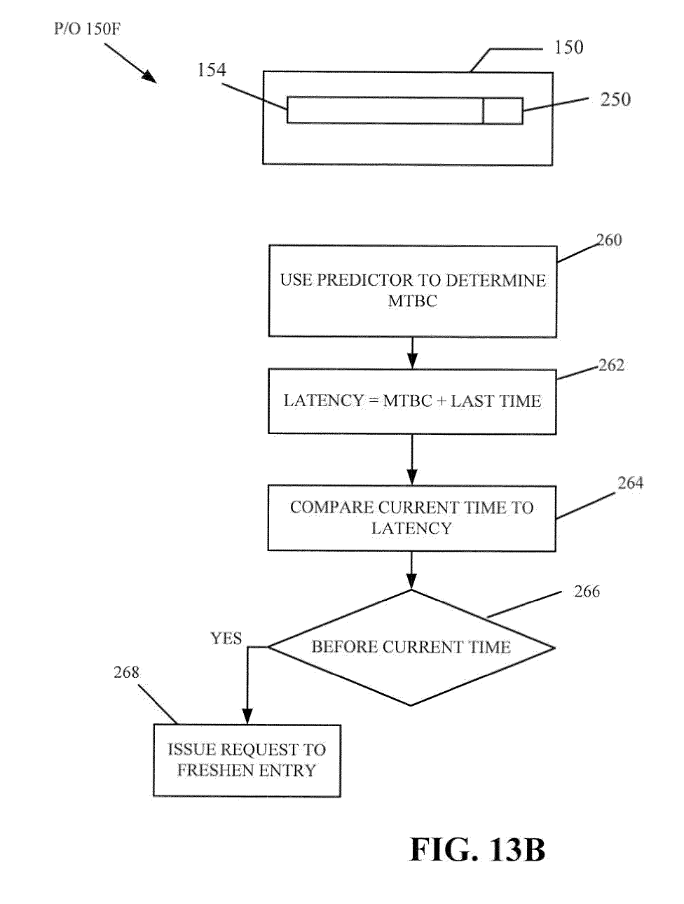

Referring to FIG. 13A, another manager process 150f controls the selection of entries and timing for cache modification by predicting when the availability information for each entry is likely to change and scheduling queries to the availability source at those times. When the availability information for an entry is not likely to have changed, a query to freshen that entry is probably wasted; while entries which are likely to change soon or likely to have changed since their last query are important to freshen.

A predictor of time between change for each entry is trained in the following fashion: collect 240 a time-stamped time series of actual availability data for many flights (e.g. query a given 10000 flights every 10 minutes for a month) and determine 242 every instance when the availability data for a given flight changed. For each change instance, the manager process 150f searches for the previous change for that flight and records 244 the time elapsed between such changes. The cache manager process 150f makes 246 a list of these flights, date stamps, and time elapsed since last change.

Salient features of the entry properties which will likely affect the meantime between changes (e.g. number of days until flight departs, day of travel, market, flight number, etc.) and use 248 standard prediction and data modeling techniques (e.g. linear regression) over the list of flights, date stamps, and times since last change to extract 250 an optimal functional mapping from the chosen feature set to the time between change. This functional mapping is a best-fit predictor of mean time between changes.

Referring to FIG. 13B, to use the predictor, augment each entry 154 in the cache with a field 250 indicating when the availability data was last changed. When the cache manager 150 is going to freshen an entry by making a query to the availability source 20c, it selects the entry to freshen as follows:

The manager uses 260 a predictor to determines for each entry E in the cache its mean time between change (MTBC). The manager adds 262 the predicted MTBC to the entry's time of last change. The manager process 150f compares 264 the new latency i.e., the sum of the predicted MTBC and entry's time to its current time and if it is before 266 the current time, the manager will issue 268 a request to freshen the availability data for the entry.

When many entries are likely to pass the test to determine if the entry should be freshed, at any given time, the manager can prioritize the candidate entries by the level of the calculated freshen time. Two ways of prioritizing are to assign a priority according to the difference between the current time and the sum, or to assign a priority according to the ratio of that difference and the MTBC.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method executed on a computer system for managing a cache including entries that correspond to seat availability information stored in the cache, the method comprises:
monitoring, by the computer system, availability queries made to the cache by a travel planning system;
determining in the computer system a demand for availability information of travel segments included in the queries for a mode of transportation;
prioritizing for update, stored answers in the cache based on the determined demand for travel segments included in the answers relative to each other;
retrieving stored answers pertaining to seat availability information from the cache;
determining if the retrieved answers are stale, and for those that are stale sending, by the computer system, availability queries to a source of seat availability information for the mode of transportation to update the answers that were determined to be stale with sending being according to the prioritizing of the stored answers.

2. The method of claim 1 wherein the mode of transportation is air and determining if the stored answer is stale further comprises:
monitoring availability queries made to the cache by the travel planning system to determine which flights, sets of flights, the flights for a certain day, date, or market have a high demand for availability information.

3. The method of claim 1 wherein determining if the stored answer is stale comprises:
scheduling a list of keys where the keys identify specific instances of transportation to update or add to the cache with the order of the keys in the list determining the order in which the specific instances are updated or added to the cache, the keys including a transportation provider, trip identification number, origin, destination, departure date, and departure time;
fetching a key to update from the list of keys;
submitting to the availability source, a query including a specific instance of transportation identified by the key; and
storing a result provided by the availability source in the cache by updating an entry if the result is present in the cache and adding an entry if the result is not present in the cache.

4. The method of claim 1 wherein determining if the stored answer is stale comprises:
scheduling multiple lists, by processing one entry from each list by a round-robin polling through the lists in turn until one entry has been processed from each list;
returning to the first list to process the next entry;
generating an entry for each entry on the list in the order given, by submitting a query to the availability source; and
storing a result provided by the availability source in the cache by updating an entry if the result is present in the cache and adding an entry if the result is not present in the cache.

5. An availability system used for a travel planning system comprises:
a cache implemented using one or more computers, the cache storing a plurality of entries of availability information of seats for a mode of transportation, the entries including previously posed availability queries, answers to the queries, and user characteristic parameters associated with users posing the availability queries; and
a computer to manage the entries in the cache, the computer configured to:
proactively populate the cache with seat availability information;
determine a quality level of entries in the cache, with the quality level of the entries in the cache determined by evaluating entries in the cache according to criteria applied to one or more of the user characteristic parameters,
the computer evaluating with greater frequency, within a given time frame, those entries that meet the criteria, wherein evaluating includes sending an availability query to a source of seat availability information for the mode of transportation based on determining that the seat availability information in the cache was stale; and
populate the cache with seat availability information provided by the source of seat availability information.

6. The availability system of claim 5 wherein the criteria includes a price that a user is willing to pay for the ticket.

7. The availability system of claim 5, wherein the criteria require the users to be frequent customers of specific airlines included in the queries.

8. The availability system of claim 5, wherein the criteria requires the users to have booked or purchased other flights on airlines included in the queries.

9. The availability system of claim 5 wherein the user characteristic parameters associated with a particular user determine whether an airline will sell a flight to the user.

10. The availability system of claim 5 wherein entries to be added, modified, or deleted are obtained by asynchronous notification from external systems.

11. The availability system of claim 5 wherein the entries are added, modified, or deleted based on the distribution of availability queries posed to the cache.

12. The availability system of claim 5 wherein the entries are added, modified, or deleted based on the frequencies with which the availability queries are posed to the cache relative to each other.

13. A computer program product residing on a computer readable medium for managing a cache for predicting availability information for a mode of transportation, comprises instructions to cause a computer to:
monitor availability queries made to the cache by a travel planning system;
determine a demand for availability information of travel segments included in the queries for a mode of transportation;
prioritize for update, stored answers in the cache based on the determined demand for travel segments included in the answers relative to each other;
retrieve stored answers pertaining to seat availability information from the cache;
determine if the retrieved answers are stale, and for those that are stale send, by the computer system, availability queries to a source of seat availability information for the mode of transportation to update the answers that were determined to be stale with sending being according to the prioritizing of the stored answers.

14. The computer program product of claim 13, wherein the mode of transportation is air and the product further comprising instructions to:
monitor the availability queries made to the cache by a travel planning system to determine which flights, sets of flights, the flights for a certain day, date, or market have a high demand for availability information.

15. The computer program product of claim 13 further comprising instructions to:
schedule a list of keys where the keys identify specific instances of transportation to update or add to the cache with the order of the keys in the list determining the order in which the specific instances are updated or added to the cache, the keys including a transportation provider, trip identification number, origin, destination, departure date, and departure time;
fetch a key to update from the list of keys;
submit to the availability source, a query including a specific instance of transportation identified by the key; and
store a result provided by the availability source in the cache by updating an entry if the result is present in the cache and adding an entry if the result is not present in the cache.

16. The computer program product of claim 13 further comprising instructions to:
schedule multiple lists, by processing one entry from each list by a round-robin polling through the lists in turn until one entry has been processed from each list, return to the first list to process the next entry;
generate an entry for each entry on the list in the order given;
submit a query to the availability source; and
store the result in the cache, by updating an entry an entry if the result is present in the cache and adding an entry if the result is not present in the cache.

17. A computer program product residing on a computer readable medium for proactively populating a cache with seat availability information, the computer program product comprising instructions to cause a computer to:
store in the cache, a plurality of entries of availability information of seats for a mode of transportation, the entries including previously posed availability queries, answers to the queries, and user characteristic parameters associated with users posing the availability queries;
determine a quality level of entries in the cache, with the quality level of the entries in the cache determined by applying criteria to one or more of the user characteristic parameters,
evaluate with greater frequency, within a given time frame, those entries that meet the criteria, wherein evaluating includes sending an availability query to a source of seat availability information for the mode of transportation based on determining that the seat availability information in the cache was stale; and
populate the cache with seat availability information provided by the source of seat availability information.

18. The computer program product of claim 17 wherein the criteria includes a price that a user is willing to pay for the ticket.

19. The computer program product of claim 17 wherein the criteria require the users to be frequent customers of specific airlines included in the queries.

20. The computer program product of claim 17 wherein the user characteristic parameters associated with a particular user determine whether an airline will sell a flight to the user.

21. The computer program product of claim 17 wherein entries to be added, modified, or deleted are obtained by asynchronous notification from external systems.

22. The computer program product of claim 17 wherein entries to be added, modified, or deleted are determined from a distribution of availability queries posed to the cache.

23. The computer program product of claim 17 wherein the entries are added, modified, or deleted based on the frequencies with which the availability queries are posed to the cache relative to each other.

24. A method executed on a computer system for managing availability information for a seat on mode of transportation, the method comprises:
filtering, by the computer system, travel scheduling data received from a seat availability source to produce instances of transportation between markets within a date range;
monitoring, by the computer system, availability queries made to the cache by a travel planning system;
determine high-demand instances of transportation included in the availability queries, the high-demand instances of transportation having a higher than average or higher than expected demand determined for the instances of transportation produced by the seat availability source;
prioritizing the high-demand instances of transportation for update over other instances of transportation produced by the seat availability source;
sending, by the computer system, availability queries to a source of seat availability information to update the instances of transportation determined to be stale, with sending being according to the prioritizing of the high-demand instances of transportation.

25. The method of claim 24 wherein the mode of transportation is air and the instances of transportation are flights, which include flights, a certain day, date, or market, which are added to the cache earlier or refreshed more often than the flights would otherwise have been added or refreshed.

26. The method of claim 24 further comprising:
observing and parsing queries made to the cache by a travel planning system; and
updating a list of entries queried along with a frequency count tallying the number of times each entry has been accessed; and
based on a frequency of access, prioritizing an entry for evaluation relative to other entries stored in the cache, the evaluation determining whether the entry is added or deleted from the cache or updated with new data from the availability source.
